(19) United States
(12) Patent Application Publication
(10) Pub. No.: US 2014/0008309 A1
(43) Pub. Date: Jan. 9, 2014

(54) AIR STRIPPING TOWER

(71) Applicant: Robert Slaby, Capistrano Beach, CA (US)

(72) Inventor: Robert Slaby, Capistrano Beach, CA (US)

(21) Appl. No.: 13/541,608

(22) Filed: Jul. 3, 2012

(51) Int. Cl. C02F 1/20

(52) U.S. Cl. CPC C02F 1/20
USPC 210/808; 210/150

(57) ABSTRACT

The present invention provides, in at least one embodiment, a system and method for producing cleaner water and air without using additional power. The system produces cleaner water by heating the sucked air, which improves the efficiency of the air stripping. The system produces cleaner air by fanning the contaminated air through a thermal oxidizer and/or a carbon filterator. The fanning is powered by a belt pulley powered by the gravitational force from the contaminated water.

### BACKGROUND OF THE INVENTION

1. Field of Invention

The invention relates generally to liquid purification, and more particularly, to an energy efficient air stripping tower that receives contaminated water and removes the volatile organic compounds (VOCs) from the contaminated water.

2. Description of Related Art

VOCs are gases that are emitted from certain solids or liquids. VOCs include a variety of chemicals, some of which may have short and long term adverse health effects. VOCs are emitted by a wide array of products, such as, for example, paints, paint strippers, cleaning supplies, pesticides, building materials and furnishings, office equipment such as copiers and printers, correction fluids and carbonless copy paper, graphics and craft materials including glues and adhesives, permanent markers, and photographic solutions.

Air stripping is a chemical engineering technology used for the purification of ground waters and wastewaters contaminated with VOCs. The technology uses a strong air stream from a powerful and energy efficient fan to remove the VOCs from the water and into the air stream. Although any device that promotes contact between air and water strips some volatile compounds, air stripping is usually in packed towers operated with countercurrent flow of water and air. The air stripping tower, also known as an air stripper, forces air bubbles through the polluted water to remove the harmful and unwanted chemicals. The air moving through the water causes the chemicals to change to a gaseous state. The gas is then bubbled out of the water with the air.

A problem with air strippers is that the VOCs are transferred from the water to the air upon contact. Colloquially speaking, the dirty water becomes dirty air. The dirty air is released into the atmosphere, the amount of which is limited by United States Environment Protection Agency (EPA) standards.

FIG. 1 illustrates a conventional air stripping system 100 according to an embodiment of the invention. The system 100 comprises an air stripping tower 105 (e.g., an air stripper), contaminated water 110, a water pump 115, an interior inlet pipe 120, fans 125, packing material 130, an air blower 135, and a clean water pipe 140. The system 100 uses air blown at a high rate of speed (e.g., 14,000 cubic feet per minute) to remove contaminants from the water producing cleaner water. The incoming dirty water may have 50 parts per million (ppm) of VOCs, whereas the exiting clean water may have 1 ppm of VOCs.

In this conventional system 100, the air rises up and out of the tower 105 through one or more conventional 720 square inch outlet air louvers. However, a problem with the system 100 is the contaminants are transferred from the water to the air, producing contaminated air being released into the environment.

In this conventional system 100, the water pump 115 pumps the contaminated water 110 up through the interior inlet pipe 120 such that it can be dispensed and spread by rotating fans 125 through packing material 130. Another problem with the system 100 is that the interior inlet pipe 120 hides leaks of the contaminated water 110 since it is not visible from the outside of the tower 105. And further, when there is a leak, the contaminated water 110 leaks into the clean water.

In this conventional system 100, theair blower 135 blows air upward through one or more conventional 360 square inch inlet air louvers. The air makes contact with the contaminated water 110. Upon contact, the air cleans the water. The clean water is drained through the clean water pipe 140. The tower 105 is elevated by the steel supports 145.

### SUMMARY OF THE INVENTION

The present invention provides, in at least one embodiment, a system and method for producing cleaner water and air without using additional power. The system produces cleaner water by heating the upward sucked air, which improves the efficiency of the air stripping. The system produces cleaner air by fanning the contaminated air through a thermal oxidizer and/or a carbon filterator. The fanning is powered by a belt pulley powered by the gravitational force from the contaminated water.

In one embodiment, a system comprises: an exterior inlet pipe configured to receive contaminated water; a hydro turbine fan attached to the exterior inlet pipe for dispensing contaminated water, wherein the contaminated water makes contact with upward sucked air producing cleaner water and contaminated air; and a belt pulley powering a pressure fan, wherein the pressure fan powers a thermal oxidizer or a carbon filterator. The system may further comprise a heater for heating the upward sucked air. The carbon filterator may be configured to capture the contaminated air and the thermal oxidizer may be configured to burn the contaminated air. The belt pulley may be powered by the gravitational force of the contaminated water. The pressure fan may comprise a pressure fan and the system may further comprise a tower, wherein the tower may comprise packing material.

In one embodiment, a method comprises the steps of: receiving contaminated water through an exterior inlet pipe; dispensing contaminated water using a hydro turbine fan attached to the exterior inlet pipe, wherein the contaminated water makes contact with upward sucked air producing cleaner water and contaminated air; and powering a pressure fan using a belt pulley, wherein the pressure fan powers a thermal oxidizer or a carbon filterator.

In a further embodiment, a system comprises: one or more mobile air stripping towers comprising: an exterior inlet pipe configured to receive contaminated water; a hydro turbine fan attached to the exterior inlet pipe for dispensing contaminated water, wherein the contaminated water makes contact with upward sucked air producing cleaner water and contaminated air; and a belt pulley powering a pressure fan, wherein the pressure fan powers a thermal oxidizer or a carbon filterator.

An advantage of the present invention is that the system produces cleaner water and air without using more energy. The system produces cleaner water due to heating the air sucked into the contaminated water. The system produces cleaner air by filtering or burning the air before emitting into the environment. The system does not using more energy because the gravitational force of the contaminated water powers a pulley system that runs the pressure fan cleaning the dirty air. An additional advantage is that the system is mobile, by eliminating of the raised steel supports.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a conventional air stripping system according to an embodiment of the invention;

FIG. 2 illustrates an air stripping system according to an embodiment of the invention;

FIG. 3 illustrates a mobile air stripping system according to an embodiment of the invention; and

FIG. 4 illustrates the process of producing cleaner water and air according to an embodiment of the invention.

### DETAILED DESCRIPTION OF EMBODIMENTS

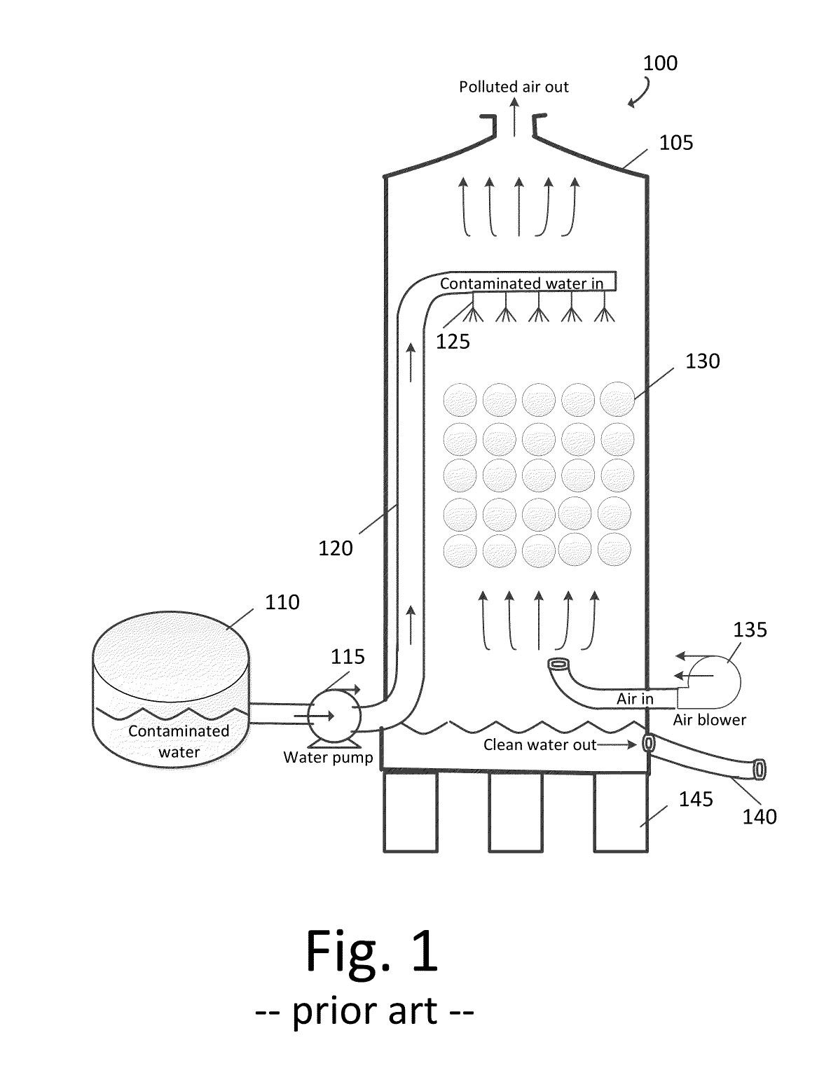

Further features and advantages of the invention, as well as the structure and operation of various embodiments of the invention, are described in detail below with reference to the accompanying FIGS. 1-4, wherein like reference numerals refer to like elements. Although the invention is described in the context of contaminated water, one of ordinary skill in the art readily appreciates that the present invention can be implemented with other fluids. Further, although a carbon filterator is shown in series with a thermal oxidizer, they can be implemented in parallel or as alternatives.

The present invention provides, in at least one embodiment, a system and method with several novel aspects for producing cleaner water and air without using more power. The present invention includes an air heater to heat the influent air which produces cleaner water due to the increased air temperature. The influent air is sucked upward through a tower by a hydro turbine fan. The present invention outputs cleaner air, by carbon treating or burning the VOCs from the exiting dirty air. Further, the system installs a belt pulley system spin a pressure fan on the effluent air side to increase pressure for treatment of air into carbon filters or thermal oxidation. Additionally, the system redirects the internal inlet water piping to an external design to eliminate cutting into the packing section and leak prevention. Further, the system redesigns the bottom of the air stripping tower from a drop down outlet to flat bottom eliminating the use of raised steel supports. This gives the towers transportable dimensions for a mobile treatment system.

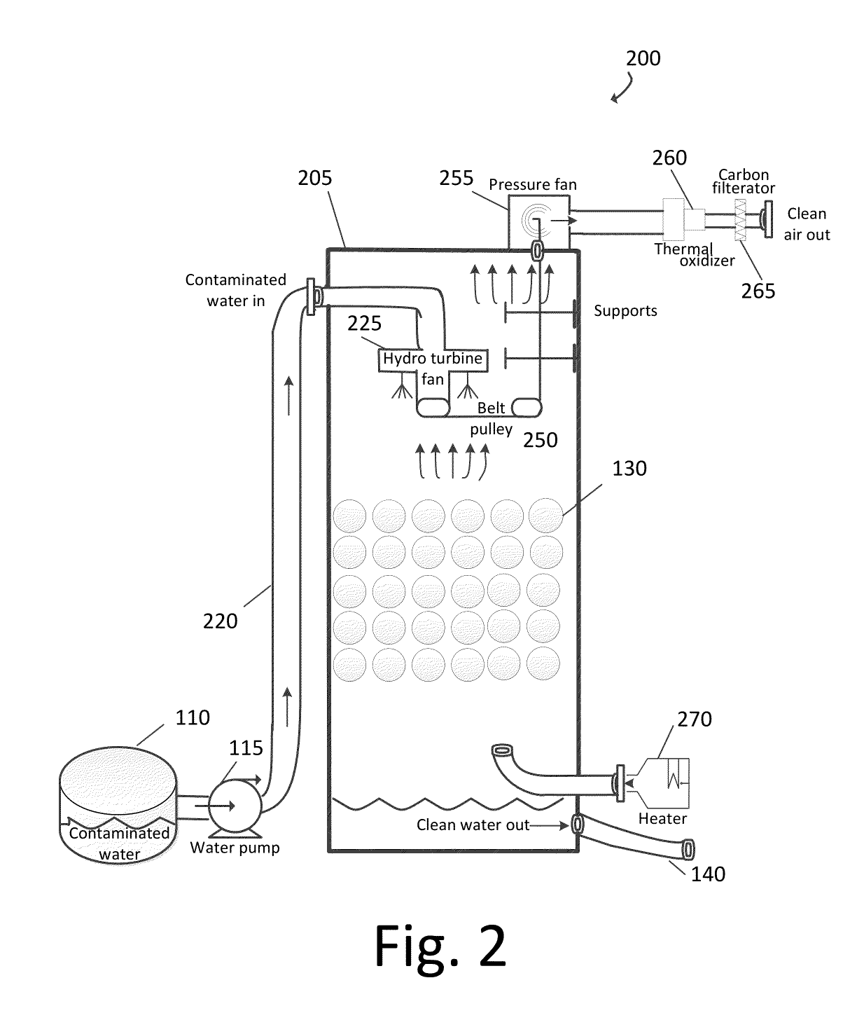

FIG. 2 illustrates an air stripping system 200 according to an embodiment of the invention. The system 200 comprises an air stripping tower 205, the contaminated water 110, the water pump 115, an exterior inlet pipe 220, a hydro turbine fan 225, the packing materials 130, a heater 235, the clean water pipe 140, a belt fan pulley 250, a pressure fan 255, a thermal oxidizer 260, and a carbon filterator 265. The system 200 produces cleaner water and air without using additional power.

The air stripping tower 205 (e.g., an air stripper) removes contaminants from water. Like the conventional tower 105, the tower 205 has counter-current air flow with air going up and into the contaminated water, which removes the contamination from the water. Unlike air stripping tower 105, which has an air blower 135 (e.g., inlet air blower, air fan, exterior air fan, etc.), the air stripping tower 205 generates air by the hydro turbine fan 225 and does not have an inlet blower. While the air stripping tower 105 uses the air blower 135 for counter-current air flow to clean the water, the air stripping tower 205 generates counter-current air flow through the hydro-turbine fan 225 and the pressure fan 255.

The tower 205 is a no electric power design. The tower 205 has a redesigned bottom which eliminates the conventional steel supports, such that the tower 205 can fit into a truck. In one embodiment, the air stripping tower 205 receives contaminated water 110 from a well pump, which can enter the tower 205 through the exterior inlet pipe 220 and a 4 inch inlet flange, and is piped to jet nozzles in the top section of the tower 205. The exterior inlet pipe 220 redirects the internal inlet water piping to an external design to eliminate cutting into the packing section and for leak prevention. The water exiting the jet nozzles activates the internal hydro turbine fan 225 causing it to rotate.

The rotating hydro turbine fan 225 draws air from the inlet air filters in the tank section up through the packing section. The hydro-turbine fan 225 spins an internal fan which generates air flow up through the bottom louvers or inlet air port of the tower 205 to the top exhaust port. Without the blower fan 135, which conventionally blows air up through the louvers, the hydro turbine fan 225 has to pull the air from the bottom up by way of the internal fan of the hydro turbine fan 225.

The hydro-turbine fan 225 is powered by the water which touches it. The air then exits the tower through the air outlet louvers in the top section of the tower 205. The rotating hydro turbine fan 225 evenly disperses the inlet water over the packing section in small droplets to maximize air to water contact. Water droplets fall through the packing into the tank section. Treated water in the tank section exits the unit through the 8″ outlet flange for delivery to a customer.

The heater 235 provides warmer air into the tower 205. In one embodiment, coils heat the air five to 10 degrees warmer. The smaller increase in temperate reduces the energy required, yet makes the air warmer which more efficiently removes contaminates from the water. The system 200 accomplishes better efficiency by replacing one or more conventional 360 square inch inlet air louvers, which receive incoming air, with one 12 inch flange fitting.

Belt pulleys 250 (e.g., belt drive, pulley system, etc.) uses the gravitational force from the downward water, spinning the belt pulleys 250, and powers the pressure fan 255. The system 200 is powered by water pressure and does not rely on electricity. The belt pulley is a key part of the invention, because it powers the pressure fan 255 while maintaining the goal of using no electricity.

The pressure fan 255 (e.g., exterior fan) receives dirty air through an installed ducting which goes to the thermal oxidizer 260 and/or the carbon filterator 265. The pressure fan 255 can receive the dirty air through one 18 inch flange connection, which replaces the conventional 720 square inch outlet air louvers. The pressure fan 255 blows strong air into the thermal oxidizer 260 and/or carbon filterator 265. The pressure fan 255 that operates via the pulley system 250 is more of a booster fan to generate pressure to push through the thermal oxidizer 260 or the carbon filterator 265. The thermal oxidizer 260 and/or carbon filterator 265 are both more effective at capturing and burning VOCs when the pressure fan 255 operates at a higher rate of speed.

The thermal oxidizer 260 (e.g., thermal oxidization) burns the contaminants from the air. Thermal oxidation, in general, is a process to control air pollution in many chemical plants that decomposes hazardous gases at a high temperature and releases them into the atmosphere. Thermal oxidizers can burn VOCs from industrial air streams.

The carbon filterator 265 (e.g., activated carbon filter, activated carbon units, carbon filteration, etc.) captures the contaminants from the air. Carbon filtering, in general, is a method of filtering that uses a piece of activated carbon to remove contaminants and impurities, utilizing chemical adsorption. Carbon filters are effective at removing VOCs from water and air. The carbon filterator 265 is illustrated as being a small unit near the top of the tower 205, but can multiple large units on the ground nearby the tower 205.

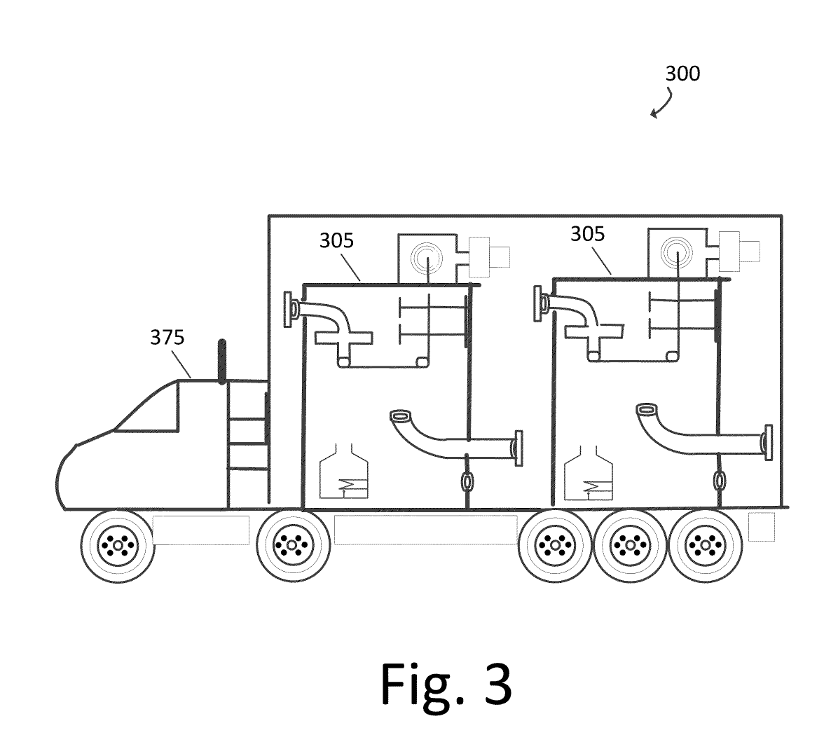

FIG. 3 illustrates a mobile air stripping system 300 according to an embodiment of the invention. The system 300 (e.g., mobile treatment system, mobile unit, etc.) includes one or more mobile air stripping towers 305. The towers 305 are designed to be shipped on a truck 375. Specifically, the towers 305 are shorter than the towers 205 since the towers 305 have to be mounted on a truck bed and truck beds have legal height limits (e.g., so they can comfortable fit under a freeway overpass). The system 300 is designed to treat water contaminated with VOCs on temporary projects which have a typical duration of about one to 24 weeks with flow rates ranging from 100 to 1,000 gallons per minute (gpm).

The system 300 can have four (not shown) low profile air stripping towers 305 on it running in a parallel configuration for inlet/outlet water streams and outlet air stream, the system 300 is pre-piped using aluminum and victaulic fittings, mechanical valves, flow meters, and solar powered monitoring devices. For pre-treatment of the water stream, there are two 500 gpm capable cartridge filters running in a parallel flow configuration for reduction of solids. All the mobile equipment can be permanently secured onto a single drop 48 foot flatbed trailer. Like the system 200, the system 300 requires no electricity.

In the mobile embodiment, the system 300 redesigns the bottom of the air stripping tower from a drop down outlet to flat bottom eliminating the use of raised steel supports. This also gives the design transportable dimensions for a mobile treatment system. Also, the towers 305 are self-contained, which enables the towers 305 to be mobile. Also, there is no waste generated. These units handle up to 250 gpm and can be scaled to multiple wells; in other words, which allows additional units to be added.

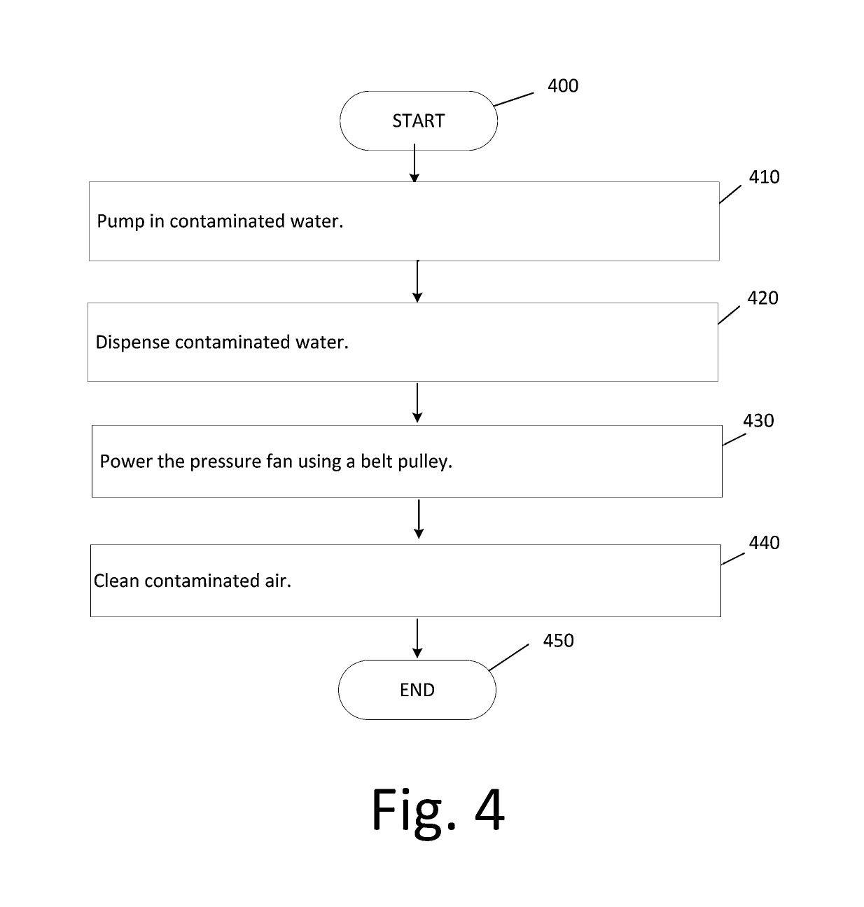

FIG. 4 illustrates the process of producing cleaner water and air according to an embodiment of the invention. The process starts at step 400. At step 410, the water pump 115 pumps the contaminated water 110 through the exterior inlet pipe 220 into the air stripping tower 205. At step 420, the hydro turbine fan 225 dispenses the contaminated water 110 through the packing material 130. The contaminated water 110 makes contact with heated air producing cleaner water and dirty air. The belt pulley 250 powers the pressure fan 255 at step 430. At step 440, the thermal oxidizer 260 and the carbon filterator 265 clean the contaminated air. The process may be repeated recursively a number of times and ends at step 450.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A system comprising:
an exterior inlet pipe configured to receive contaminated water;
a hydro turbine fan attached to the exterior inlet pipe for dispensing contaminated water, wherein the contaminated water makes contact with upward sucked air producing cleaner water and contaminated air; and
a belt pulley powering a pressure fan, wherein the pressure fan powers a thermal oxidizer or a carbon filterator.

2. The system of claim 1, further comprising a heater for heating the upward sucked air.

3. The system of claim 1, wherein the carbon filterator is configured to capture the contaminated air.

4. The system of claim 1, wherein the thermal oxidizer is configured to burn the contaminated air.

5. The system of claim 1, wherein the belt pulley is powered by the gravitational force of the contaminated water.

6. The system of claim 1, wherein the pressure fan comprises a pressure fan.

7. The system of claim 1, further comprising a tower.

8. The system of claim 7, wherein the tower comprises packing material.

9. A method comprising:
receiving contaminated water through an exterior inlet pipe;
dispensing contaminated water using a hydro turbine fan attached to the exterior inlet pipe, wherein the contaminated water makes contact with upward sucked air producing cleaner water and contaminated air; and
powering a pressure fan using a belt pulley, wherein the pressure fan powers a thermal oxidizer or a carbon filterator.

10. A system comprising:
one or more mobile air stripping towers comprising:
an exterior inlet pipe configured to receive contaminated water;
a hydro turbine fan attached to the exterior inlet pipe for dispensing contaminated water, wherein the contaminated water makes contact with upward sucked air producing cleaner water and contaminated air; and
a belt pulley powering a pressure fan, wherein the pressure fan powers a thermal oxidizer or a carbon filterator.
